(19) United States
(12) Patent Application Publication
(10) Pub. No.: US 2007/0224010 A1
(43) Pub. Date: Sep. 27, 2007

(54) Locking device for securing loads

(76) Inventor: Jeffrey E. Cunningham, Nashville, IL (US)

Correspondence Address: Ms. Soula Skokos;Suite 220, 1100 Jorie Boulevard, Oak Brook, IL, 60523, US

(21) Appl. No.: 11/635,219

(22) Filed: Dec. 6, 2006

Related U.S. Application Data
(63) Continuation-in-part of application No. 11/389,628, filed on Mar. 24, 2006.

(51) Int. Cl. B60P 7/15

(52) U.S. Cl. 410/143

(57) ABSTRACT

A locking device for securing loads in the bed of a pick-up truck, moving truck hauler, and for use generally in locking loads being transported in any type of truck.

### CROSS REFERENCE TO RELATED APPLICATION

The present application is a continuation-in-part of application Ser. No. 11/389,628 filed on Mar. 24, 2006 by the present applicant.

### BACKGROUND OF THE INVENTION

### Field of the Invention

This invention relates to a locking device for securing loads in the bed of a pick-up truck, moving truck hauler, or any other type of transport vehicle and for use generally in locking loads being transported in any type of truck.

Pick-up trucks are very popular vehicles and in part, this popularity is due to their load carrying capacity and compact size, together with other factors such as maneuverability, fuel economy and versatility. One disadvantage of pick-up trucks, however, is that they are not generally equipped with anchor points to secure and restrain loads. In some cases, stake pockets are provided in the rim or lip of the box but these are often inadequate and of course, it may be necessary to keep them free for their intended purpose.

Currently, pick-up truck drivers use two-by-fours and other such types of support bars across the width of the bed to secure and restrain loads. Pick up drivers typically create entire blocks of two-by-fours in order to secure the loads that are being transported in the bed of the trucks. Such efforts are significantly time consuming. Also, the construction of such blocks are not durable over time to be used and reused with different loads. While the use of two-by-fours is the trusted method among drivers to secure loads, currently there are no means by which to quickly, easily and safely secure such two-by-fours or other support bars to the bed of the pick-up truck, moving truck hauler or other type of transport vehicle.

The object of this invention is to provide a locking device for use with a pick-up truck bed, moving truck hauler or other type of transport vehicle, which will facilitate the safe transportation of loads which may be installed with minimal effort and minimum alteration to the vehicle. The present invention allows the user to quickly, easily and safely secure a load in the bed of the pick-up truck at any point along the length of the bed, even towards the front of the bed. The present invention further allows the user to safely secure a load in the bed of the pick-up truck at any point along the height of the bed, even towards the bottom of the bed.

### BRIEF SUMMARY OF THE INVENTION

The locking device of the present invention is attached to the side walls of the bed of a pick-up truck, moving truck hauler or other type of transport vehicle, and comprises of at least two support rails affixed to each interior side wall of the bed and extending lengthwise or height wise along the interior of the bed, at least two lock blocks having at least two right angled projections extending from the top and bottom portions of each lock block in order to slide onto each support rail, at least two housing units into which the ends of at least one two-by-four or other types of support beams fit where each housing unit fits over each lock block and each housing unit has at least four projections that push into the top and bottom grooves of each of the support rails, and at least two hinged locking handles connected to each housing unit where each hinged locking handle has at least one locking arm at the housing unit end that forms a cam that when the hinged locking handle is engaged locks each housing unit and lock block into each corresponding support rail and also secures the at least one two-by-four or other types of support beams into place in each housing unit.

### BRIEF DESCRIPTION OF THE DRAWINGS

FIG. 1 is a front perspective view of two locking devices each designed in accordance with an embodiment of the present invention, the figure illustrating each locking device in the engaged (locked) position.

FIG. 2 top perspective view of two locking devices each designed in accordance with an embodiment of the present invention, the figure illustrating each locking device in the engaged (locked) position.

FIG. 3 is a front perspective view of two locking devices each designed in accordance with an embodiment of the present invention, the figure illustrating each locking device in the disengaged (open) position.

FIG. 4 is a side cutaway view of a pair of locking devices designed in accordance with an embodiment of the present invention, the figure illustrating a locking device pair securing a two-by-four or other type of support beam, wherein one locking device is in the engaged (closed) position and the other locking device is in the disengaged (open) position; and

FIG. 5 is a front perspective view of a locking device designed in accordance with an embodiment of the present invention, the figure illustrating the locking device in the disengaged (open) position securing a two-by-four or other type of support beam.

FIG. 6 is a perspective and cross sectional view of a support rail in accordance with another embodiment of the present invention.

FIG. 7 is a perspective and cross sectional view of a support rail in accordance with another embodiment of the present invention.

FIG. 8 is a perspective exploded view of a locking device designed in accordance with another embodiment of the present invention, illustrating how the lock block secures onto the support railing and then fits into the housing unit.

FIG. 9 is a perspective exploded view of a locking device designed in accordance with another embodiment of the present invention, illustrating how the lock block secures onto the support railing and then fits into the housing unit.

### DETAILED DESCRIPTION OF THE DRAWINGS

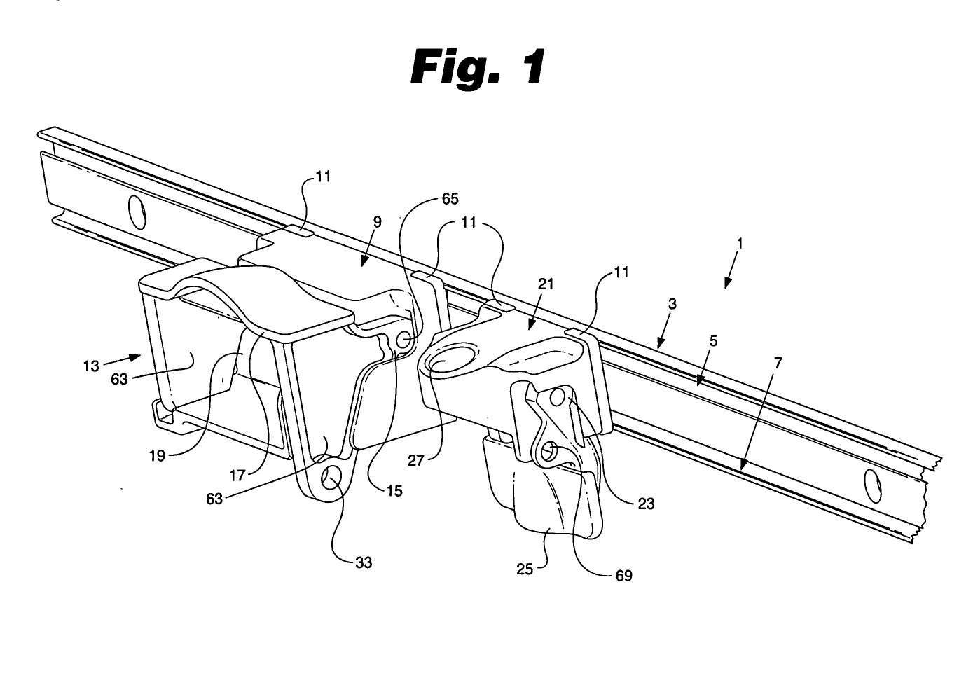

A locking device, according to the present invention, is shown at 1 in FIG. 1. FIG. I illustrates two embodiments of the locking device wherein one embodiment may be used to secure a two-by-four or other type of support beam and another embodiment that may be used to secure rope, thread or other securing means. The locking device 1 of the present invention that may be used to secure a two-by-four or other type of support beam has at least two support rails 3 affixed to each interior side wall of the bed of a pickup truck, moving truck hauler or any other type of transport vehicle, and extending lengthwise or height wise along such interior, at least two lock blocks (not shown) having at least two right angled projections extending from the top and bottom portions of each lock block in order to slide onto each support rail 3 and each lock block (not shown) having a center projection with at least one through hole, at least two housing units 9 into which the ends of at least one two-by-four or other types of support beams fit where each housing unit 9 fits over each lock block (not shown) and each having at least one through hole or opening (not shown) that aligns with the through hole in each lock block (not shown) and having at least four projections 41 on the back side of each housing unit 9 that push into the top groove 5 and bottom groove 7 of each of the support rails 3, and at least two hinged locking handles 13 connected to each housing unit 9 where each hinged locking handle 13 has at least one locking arm 15 at the housing unit end that forms a cam that when the hinged locking handle 13 is engaged locks each housing unit 9 and lock block 51 into each corresponding support rail 3 and also secures the at least one two-by-four or other types of support beams into place in each housing unit 9.

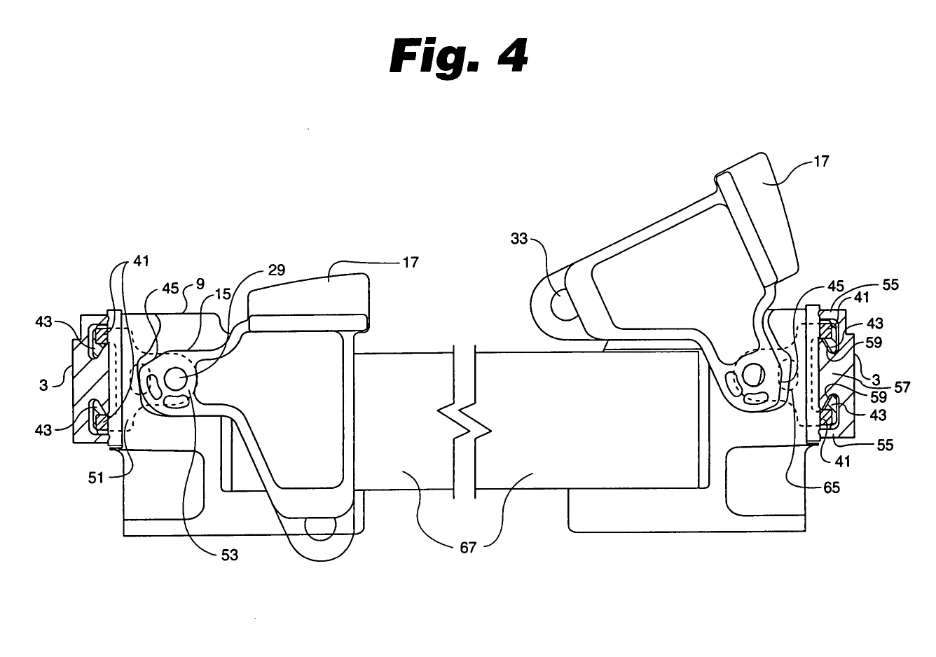

In one embodiment, the at least two support rails 3 may be E shaped in profile, as shown in FIG. 4, such that each support rail contains a lip 55 at the top side and bottom side of the support rail 3 and a center projection 57. The side walls 59 of the center projection of the support rail 3 may angle outward such that the height of the center projection 57 may be greater at its distal end than the height of the center projection 57 at its proximal end near the back wall of the support rail 3. Preferably, the side walls 59 of the center projection 57 may angle out at an angle approximate to 60 degrees from the center of the center projection 57.

In the present invention, the at least two lock blocks 51, as shown in FIG. 4, slide onto the at least two support rails 3 that have been attached to the interior side walls of the bed of the pickup truck, moving truck hauler or any other type of transport vehicle. The at least two right angled projections 43 of each lock block 51 slide into the top groove 5and bottom groove 7 of each support rail 3. Each lock block 51 has a center projection 57 containing at least one through hole or opening 29 that aligns with a through hole or opening (not shown) in the corresponding housing unit 9.

Each housing unit 9 of the present invention has one bottom wall 34, a top wall 39, two side walls 35, a cavity (not shown) in the backside of the housing unit 9 into which the lock block 51 fits, and a back wall 19 with at least four projections 41 extending from the back side of each housing unit 9 that fit into the top groove 5 and bottom groove 7 of the support rail 3. The front side of the back wall 19 has at least two indentations or grooves 61 into which the end of the locking arm 15 of the hinged locking handle 13 fits. The back wall 19 of the housing unit 9 further has at least one through hole (not shown) that extends throughout the housing unit 9 and is aligned with the through hole 29 in the lock block 51.

The hinged locking handle 13 may have a top portion 17 which the user may depress to activate the hinged locking handle 13, and two side panels 63 each containing a locking arm 15 that fit into the indentations or grooves 61 of the back wall 19 of the housing unit 9, wherein each locking arm 15 of the hinged locking handle 13 ends in a cam. The end of each locking arm 15 further has a through hole or opening 65 that is aligned with the through hole in the housing unit (not shown) and through hole 29 in the lock block 51.

In the present invention, there may be one pin that is placed through the through holes 65 of the locking arms 15 of each hinged locking handle 13, the through hole of each housing unit (not shown) and the through hole 29 of each lock block 51, in order to transform the components of the locking device 1 into a single functioning unit.

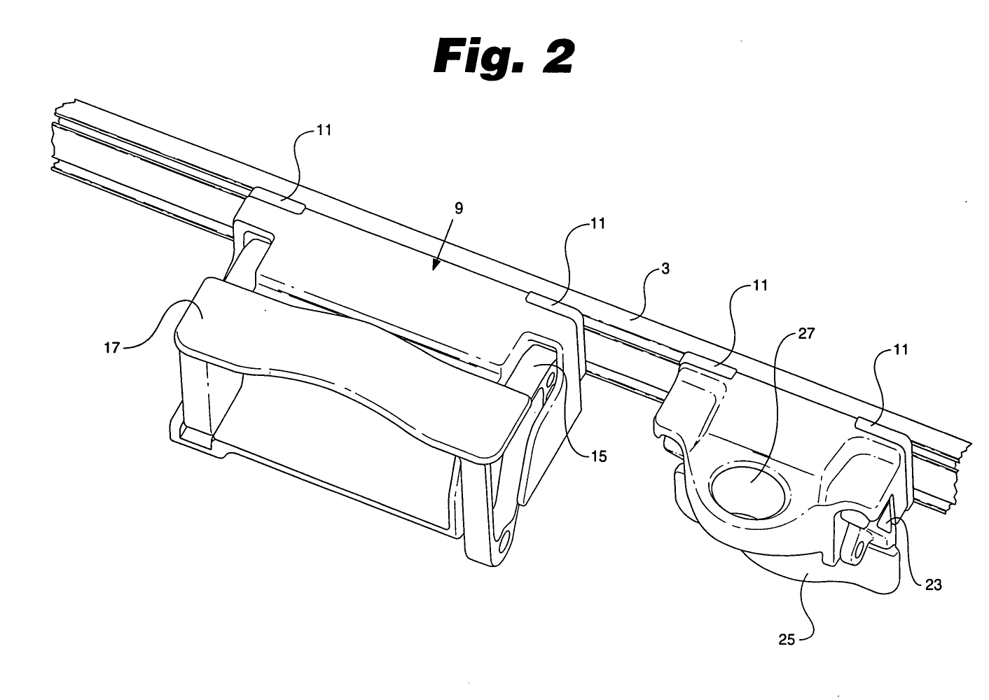

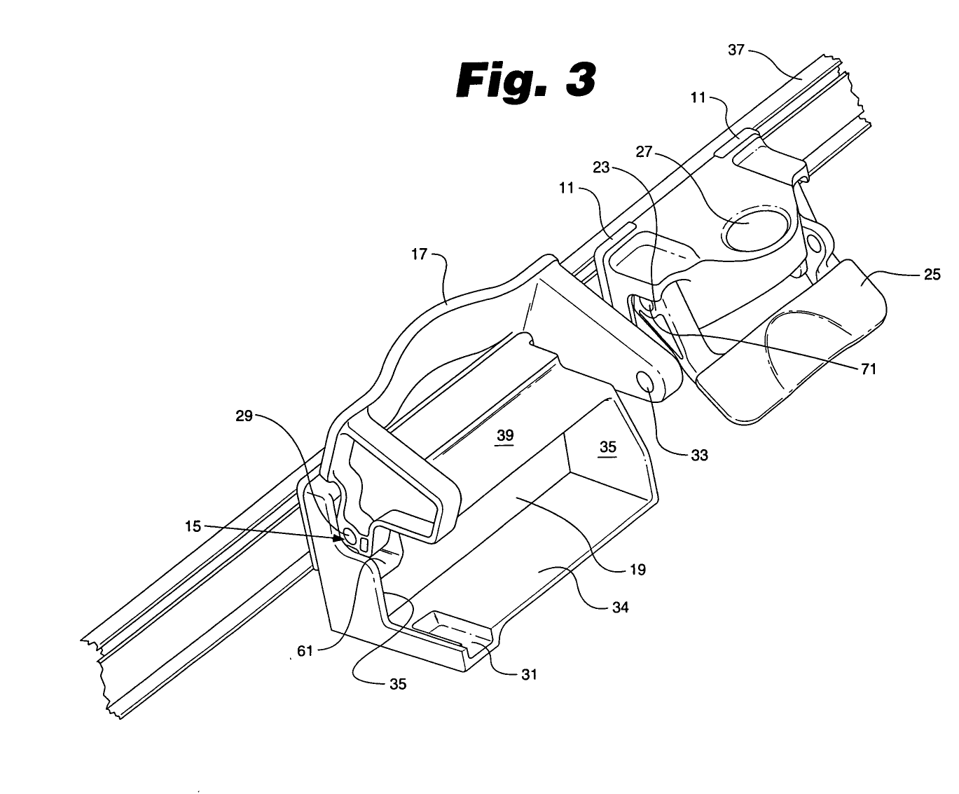

In the disengaged (open) position of the locking device 1, as shown in FIG. 3, the hinged locking handle 13 is in a raised position. To move the hinged locking handle 13 into the engaged (locked) position, as shown in FIG. 2, to secure the two by four or other type of support bars into the housing unit 9, the user depresses the top portion 17 of the hinged locking handle 13 to cause the locking arm 15 to rotate downward toward the bottom wall 34 of the housing unit 9 and the end of the locking arm 15 that forms a cam rotates relative to the pin placed through the through holes to then become engaged with the back wall of the indentations or grooves 61 of the housing unit 9.

The cam at the end of the locking arm 15 is preferably a solid design and is substantially round in shape including a flatter portion 45. FIG. 4 illustrates the locking device 1 in a disengaged (open) position wherein the hinged locking handle 13 is raised above the at least one two-by-four or other types of support beams 67 placed in each housing unit 9. FIG. 4 further illustrates the locking device 1 in the engaged (locked) position, where the top portion 17 of the hinged locking handle 13 has been depressed such that the top portion 17 is nearly parallel with the at least one two-by-four or other types of support beams 67 that is secured in place in each housing unit 9.

When the hinged locking handle 13 is in the disengaged (open) position, the flatter portion 45 of the cam is nearly parallel with the back wall of the indentation or groove 61 of the housing unit 9. As the user depresses the top portion 17 of the hinged locking handle 13, the cam rotates relative to the pin (not shown) placed through the through hole 29 in the lock block 51 and the flatter portion 45 of the cam rotates upward toward the top wall 39 of the housing unit 9 to the point where the positioning of the cam impedes the movement of the hinged locking handle 13 thereby locking the hinged locking handle 13 into place and also consequently securing the two-by four or other type of support bar 67 into place. Further, while the user is depressing the top portion 17 of the hinged locking handle 13 and the cam is rotating relative to the pin, the flatter portion 45 of the cam applies a force upon the indentation or groove 61 of the housing unit 9 whereby the housing unit 9 is pushed further into the support rails 3 because the at least four projections 41 extending from the back side of each housing unit 9 are being forced further into the top grove 5 and bottom groove 7 of each of the support rails 3. By fully depressing the top portion 17 of the hinged locking handle 13, each housing unit 9 is locked into the support rail 3. In addition to locking the housing unit 9 into the support rail 3, by fully depressing the top portion 17 of the hinged locking handle 13, the rotation of the cam also forces the lock block 51 to be locked into the support rail 3 because the lock block 51 is thereby pulled toward the housing unit 9 such that the right angled projections 43 of each lock block become flush with the side walls 59 of the support rail 3. By fully depressing the top portion 17 of the hinged locking handle 13, each lock block 51 is locked into the support rail 3.

In one embodiment of the invention, there may be at least two cushions that are placed between each housing unit 9 and support rail 3. While the user is depressing the top portion 17 of the hinged locking handle 13 to engage the locking device 1, the at least two cushions 11 are compressed to enable the at least four projections 41 extending from the back side of each housing unit 9 to be further forced into the top groove 5 and bottom groove 7 of the support rails 3. The at least two cushions 41 allow for greater amount of give to further secure the locking device 1. The at least two cushions 11 further have slots or openings (not shown) that allow the at least four projections 41 to protrude through the at least two cushions 11 into the top groove 5 and bottom groove 7 of the support rails 3.

The hinged locking handle 13 may also have one side wall 63 that contains an opening or through hole 33 through which a lock may be placed when the hinged locking handle 13 is engaged to further secure the two-by-four or other support beams into place and to prevent theft of the locking device 1.

The bottom wall 34 of the housing unit 9 may contain at least one notch or groove 31 into which the end of at least one side wall 63 of the hinged locking handle 13 may fit when the hinged locking handle 13 is in the engaged (closed) position.

In another embodiment of the present invention, the locking device 1 may be used to secure rope, thread or other securing means. In this embodiment, as shown in FIG. 1, the housing unit 21 has an opening 27 though which a user may pass through an end of a rope, thread or any other securing means. As in the embodiment used to secure the at least one two-by-four or other types of support beams, the housing unit 21 fits over each lock block (not shown) and has at least one through hole or opening (not shown) that aligns with the through hole in each lock block (not shown). Also, as in the embodiment used to secure the at least one two-by-four or other types of support beams, the housing unit 21 has at least four projections 41 on the back side of each housing unit 21 that push into the top groove 5 and bottom groove 7 of each of the support rails 3. In this embodiment, the locking device 1 has least one hinged locking handle 25 connected to each housing unit 21 where each hinged locking handle 25 has at least one locking arm 23 at the housing unit end that forms a cam that when the hinged locking handle 25 is engaged locks each housing unit 21 and lock block (not shown) into each corresponding support rail 3.

The at least two support rails 3 of the present invention may contain openings for means of attaching the at least two support rails 3 to the interior side walls of the bed of a pick up truck, moving truck hauler or any other type of transport vehicle. The opening in the at least two support rails 3 may be used to drill attachment means into the interior side walls of the vehicle.

One advantage of the present invention is that the locking device 1 may be moved anyplace along the length or height of the interior of the bed and then locked into placed at any point along the length or height of the interior of the bed of a pick up truck, moving truck hauler or any other type of transport vehicle.

Preferably, the at least two support rails 3 may be affixed to the interior side walls of the bed of a pick up truck or any other type of transport vehicle directly beneath the lip of the bed. Preferably, the width of the support rail 3 is equal to or less than the width of such lip such that the support rail 3 does not impede any loading or unloading of objects into the bed when the locking device 1 is not in use. Alternatively, the at least two support rails 3 may not be affixed to the interior side wall of the bed but rather is mounted to the lip of the bed by bracketing means.

In another embodiment of the invention, the locking arm 15 does not end in a cam but is replaced with a one way clutch mechanism. In this embodiment, the indentation or groove 61 of the back wall of the housing unit 9 and the end of the locking arm 15 of the hinged locking handle 13 create a one way clutch mechanism such that the depression of the top portion 17 of the hinged locking handle 13 locks the hinged locking handle 13 and raising the top portion 17 of the hinged locking handle 13 unlocks the hinged locking handle 13. The one way clutch may be accomplished through any conventional clutch means including but not limited to sprags, v-type springs, according springs, ribbon springs or any other conventional type of spring, or a freewheel clutch.

In another embodiment of the present invention, the at least two support rails 3 may be affixed to the interior side walls of the bed of a pick up truck or any other type of transport vehicle parallel to the lip of the bed. As shown in FIG. 7, the back wall 69 of the at least one support rail 3 may be chamfered, beveled, recessed, cut away, angled, or rounded to allow the chamfer 71 of the back wall 69 of the at least two support rails 3 to line up with the lip of the bed of a pick up truck. In the alternative, the back wall 69 of the at least two railings 3 may be stepped with at least two steps 73 and 75, as shown in FIG. 6, to allow the back wall 69 of the at least two support rails 3 to line up with the lip of the bed of a pick up truck.

In another embodiment of the invention, the at least two support rails 3 may have profiles as shown in FIG. 6, wherein the back wall 69 of the at least two railings 3 may be stepped with at least two steps 73 and 75. The at least two lock blocks 51 (not shown) slide onto the at least two support rails 3 as shown in FIG. 6 where the at least two right angled projections 43 of each lock block 51 slide on to and press against the back wall 69 of the support rail 3.

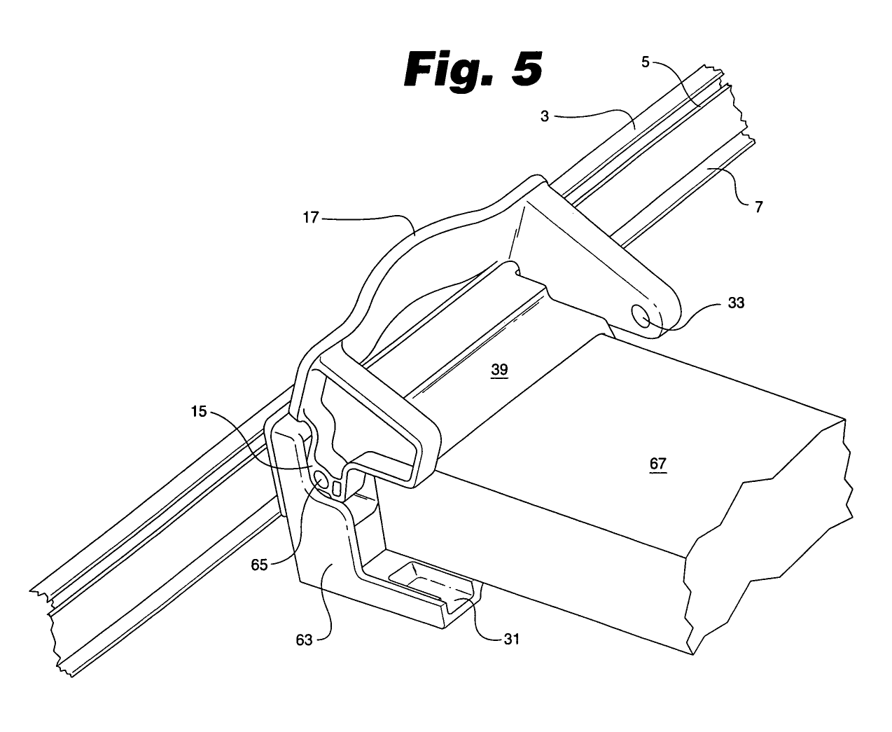

In another embodiment of the invention, the lock block 5 1, the housing unit 9 and the hinged locking handle 13 may be spring loaded to easily enable the user to engage and disengage the hinged locking handle. FIGS. 8 and 9 illustrate an exploded view of the at least two support rails 3, the lock block 51, the housing unit 9 and hinged locking handle 13, and at least one spring that connects the lock block 51 to the housing unit 9 and hinged locking handle 13. The at least one spring 77 further enables the user to easily slide the lock block 51, the housing unit 9 and hinged locking handle 13, on to the support rail 3.

The foregoing disclosure has been set forth to illustrate the invention and is not intended to be limiting. Alternative modifications of the disclosed embodiments incorporating the spirit and substance of the invention will occur to persons skilled in the art, and accordingly the invention should be construed to include everything that falls within the scope of the appended claims and equivalents thereof.

What is claimed is:

1. A locking device for use in securing loads in the bed of a pick-up truck, moving truck hauler, or any other type of transport vehicle comprising:
at least two support rails affixed to the interior side wall of the bed of a pick-up truck, moving truck hauler, or any other type of transport vehicle;
at least two lock blocks that each slide on to each support rail;
at least two housing units that each fits over each lock block and into which the ends of at least one two-by-four or other types of support beams may fit; and
at least two hinged locking handles that each is connected to each housing unit and may be engaged to secure at least one two-by-four or other types of support beams into place and to secure the at least two lock blocks and at least two housing units into the corresponding support rails.

2. A locking device of claim 1, wherein the at least two hinged locking handles have a locking arm ending in a cam that when the at least two hinged locking handles are engaged the cam rotates and applies a force upon the at least two housing units and the at least two lock blocks securing the at least two housing units and the at least two lock blocks into the corresponding support rails.

3. A locking device of claim 1, wherein there are at least two cushions placed between the at least two housing units and corresponding support rails that may be compressed when the hinged locking handle is engaged to secure the at least two housing units and at least two lock blocks into the at least two support rails.

4. A locking device of claim 1, wherein there is a pin placed through the openings or through holes in the at least two hinged locking handles, at least two housing units, and at least two lock blocks to secure the locking device as a single functioning unit.

5. A locking device of claim 1, wherein the hinged locking handle may have an opening to allow the locking device to be locked with a padlock or deadbolt.

6. A locking device of claim 1, wherein the at least two support rails may have openings or through holes for means of attaching the at least two support rails to the interior side walls of the bed of a pick up truck, moving truck hauler or any other type of transport vehicle.

7. A locking device of claim 1, wherein the at least two hinged locking handles and at least two housing units create a one way clutch mechanism to secure the at least one two-by-four or other types of support beams into place.

8. A locking device of claim 1, wherein the at least two support rails are affixed lengthwise to the interior side walls of the bed of a pick up truck, moving truck hauler or any other type of transport vehicle.

9. A locking device of claim 1, wherein the at least two support rails are affixed height wise to the interior side walls of the bed of a pick up truck, moving truck hauler or any other type of transport vehicle.

10. A locking device of claim 1, wherein the at least two lock blocks are spring loaded to the at least two housing units and at least hinged locking handles.

11. A locking device of claim 1, wherein the back wall of the at least two support rails are chamfered such that the at least two support rails may be affixed parallel to a lip of the bed of a pick up truck.

12. A locking device for use in securing loads in the bed of a pick-up truck, moving truck hauler, or any other type of transport vehicle comprising:
at least two support rails affixed to the interior side wall of the bed of a pick-up truck, moving truck hauler, or any other type of transport vehicle;
at least two lock blocks that each slide on to each support rail;
at least two housing units that each fits over each lock block and into which the end of a piece of rope, thread or other securing means may pass through; and
at least two hinged locking handles that each is connected to each housing unit and may be engaged to secure the at least two lock blocks and at least two housing units into the corresponding support rails.

13. A locking device of claim 12, wherein the at least two hinged locking handles have a locking arm ending in a cam that when the at least two hinged locking handles are engaged the cam rotates and applies a force upon the at least two housing units and at least two lock blocks securing the at least two housing units and at least two lock blocks into the corresponding support rails.

14. A locking device of claim 12, wherein there are at least two cushions placed between the at least two housing units and corresponding support rail that may be compressed when the hinged locking handle is engaged to secure the at least two housing units and at least two lock blocks into the at least two support rails.

15. A locking device of claim 12, wherein there is a pin placed through the openings or through holes in the at least two hinged locking handles, at least two housing units, and at least two lock blocks to secure the locking device as a single functioning unit.

16. A locking device of claim 12, wherein the hinged locking handle may have an opening to allow the locking device to be locked with a padlock or deadbolt.

17. A locking device of claim 12, wherein the at least two support rails may have openings or through holes for means of attaching the at least two support rails to the interior side walls of the bed of a pick up truck, moving truck hauler or any other type of transport vehicle.

18. A locking device of claim 12, wherein the at least two hinged locking handles and at least two housing units create a one way clutch mechanism to secure the at least one two-by-four or other types of support beams into place.

19. A locking device of claim 12, wherein the at least two support rails are affixed lengthwise to the interior side walls of the bed of a pick up truck, moving truck hauler or any other type of transport vehicle.

20. A locking device of claim 12, wherein the at least two support rails are affixed height wise to the interior side walls of the bed of a pick up truck, moving truck hauler or any other type of transport vehicle.

21. A locking device of claim 12, wherein the at least two lock blocks are spring loaded to the at least two housing units and at least hinged locking handles.

22. A locking device of claim 12, wherein the back wall of the at least two support rails are chamfered such that the at least two support rails may be affixed parallel to a lip of the bed of a pick up truck.
